(19) United States
(12) Patent Application Publication
(10) Pub. No.: US 2024/0169487 A1
(43) Pub. Date: May 23, 2024

(54) IMAGE PROCESSING METHOD AND DEVICE

(71) Applicant: Beijing Zitiao Network Technology Co., Ltd., Beijing (CN)

(72) Inventor: Mingjin CHEN, BEIJING (CN)

(21) Appl. No.: 18/551,725

(22) PCT Filed: Apr. 12, 2022
(86) PCT No.: PCT/CN2022/086283

§ 371 Date: Sep. 21, 2023

(30) Foreign Application Priority Data
Apr. 12, 2021 (CN) 202110389102.7

(51) Int. Cl. G06T 5/50; G06T 7/11; G06T 7/90

(52) U.S. Cl. CPC G06T 5/50; G06T 7/11; G06T 7/90; G06T 2207/10024; G06T 2207/20021; G06T 2207/20221

(57) ABSTRACT

The present disclosure provides an image processing method and device. Wherein, an original image is divided into a plurality of original regions, the plurality of original regions at least comprising a first region and a second region; wherein the luma values of pixel points in the first region are greater than the luma values of pixel points in the second region, a reference image is divided into into a plurality of reference regions, the reference regions at least comprising a third region and a fourth region; wherein the luma values of pixel points in the third region are greater than the luma values of pixel points in the fourth region, a transformation matrix for the first region is obtained based on color values of pixel points in the first region and color values of pixel points in the third region, and a transformation matrix for the second region is obtained based on color values of pixel points in the second region and color values of pixel points in the fourth region, and color mapping is performed on the original image according to the transformation matrix for the first region and the transformation matrix for the second region to obtain a target image. In this way, the target image is more natural, and is closer to the reference image in color tone, and the filter migration effect is good.

### CROSS-REFERENCE OF RELATED APPLICATION

The present disclosure claims the priority of a Chinese patent application No. 202110389102.7 filed on Apr. 12, 2021, which is hereby incorporated by reference in its entirety.

### FIELD OF THE INVENTION

The present disclosure relates to a technical field of computer vision, and in particular to an image processing method and device.

### BACKGROUND

In many scenarios, it is necessary to perform filter migration operations on an image or a video, that is, to adjust a color tone style of the original image/video according to a color tone style of a reference image/video, so that the color tone of the original image/video is consistent with the color tone of the reference image/video.

The existing filter migration method matches histogram of each channel of the original image with the histogram of each channel of the reference image, so that the histogram of each channel of the original image is close to that of the reference image.

However, the effect of filter mitrigation obtained in this way is not good.

### DISCLOSURE OF THE INVENTION

In order to solve the above technical problems, the present disclosure provides an image processing method and device.

In a first aspect, the present disclosure proposes an image processing method, including:
dividing an original image into a plurality of original regions, the plurality of original regions at least comprising a first region and a second region, wherein luma values of pixel points in the first region are greater than the luma values of pixel points in the second region,
dividing a reference image into into a plurality of reference regions, the reference regions at least comprising a third region and a fourth region, wherein the luma values of pixel points in the third region are greater than the luma values of pixel points in the fourth region,
obtaining a transformation matrix for the first region based on color values of pixel points in the first region and color values of pixel points in the third region, and obtaining a transformation matrix for the second region based on color values of pixel points in the second region and color values of pixel points in the fourth region,
color mapping the original image according to the transformation matrix for the first region and the transformation matrix for the second region to obtain a target image.

In some embodiments, the obtaining a transformation matrix for the first region based on color values of pixel points in the first region and color values of pixel points in the third region, and obtaining a transformation matrix for the second region based on color values of pixel points in the second region and color values of pixel points in the fourth region, comprising:
calculating a covariance matrix of color channel dimensions corresponding to each of the plurality of original regions, based on the color values of pixel points in the original region;
calculating a covariance matrix of color channel dimensions corresponding to each of the plurality of reference regions, based on the color values of pixel points in the reference region;
determining the transformation matrix for the first region based on the covariance matrix of the color channel dimensions corresponding to the first region and the covariance matrix of the color channel dimension corresponding to the third region; and
determining the transformation matrix for the second region based on the covariance matrix of the color channel dimensions corresponding to the second region and the covariance matrix of the color channel dimension corresponding to the fourth region.

In some embodiments, the color mapping the original image according to the transformation matrix for the first region and the transformation matrix for the second region to obtain a target image, comprising:
processing the color values of pixel points in the original image according to the transformation matrix for the first region to obtain a first corrected image corresponding to the transformation matrix for the first region,
processing the color values of pixel points in the original image according to the transformation matrix for the second region to obtain a second corrected image corresponding to the transformation matrix for the second region, and
fusing the first corrected image and the second corrected image to obtain the target image.

In some embodiments, the color mapping the original image according to the transformation matrix for the first region and the transformation matrix for the second region to obtain a target image, comprising:
processing the color values of the pixel points in the first region according to the transformation matrix for the first region to obtain a first corrected region corresponding to the first region,
processing the color values of the pixel points in the second region according to the transformation matrix for the second region to obtain a second corrected region corresponding to the second region, and
stitching the first corrected region and the second corrected region to obtain the target image.

In some embodiments, the dividing the original image into the plurality of original regions, comprising:
arranging the pixel points in the original image in order of the luma values from low to high to determine at least one first cutoff value;
dividing the pixel points in the original image into the plurality of original regions based on the at least one first cutoff value;
the dividing the reference image into the plurality of reference regions, comprising:
   arranging the pixel points in the reference image in order of the luma values from low to high to determine at least one second cutoff value;
   dividing the pixel points in the reference image into the plurality of reference regions based on the at least one second cutoff value.

In some embodiments, the plurality of original regions further comprise a fifth region, and the luma values of the pixel points in the fifth region are greater than the luma values of the pixel points in the first region, or, the luma values of the pixel points in the fifth region are smaller than the luma values of the pixel points in the second region;

the reference regions also comprise a sixth region, wherein the luma values of the pixel points in the sixth region are greater than the luma values of the pixel points in the third region, or the luma values of the pixel points in the sixth region are smaller than luma values of pixel points in the fourth region;

wherein the method also comprises:
obtaining a transformation matrix for the fifth region based on the color values of the pixel points in the fifth region and the color values of the pixel points in the sixth region;
the color mapping the original image according to the transformation matrix for the first region and the transformation matrix for the second region to obtain a target image, comprises:
   color mapping the original image according to the transformation matrix for the first region, the transformation matrix for the second region and the transformation matrix for the fifth region, to obtain the target image.

In a second aspect, the present disclosure proposes an image processing device, comprising:
a region division module, configured to divide an original image into a plurality of original regions, the plurality of original regions at least comprising a first region and a second region, wherein luma values of pixel points in the first region are greater than the luma values of pixel points in the second region, and divide a reference image into into a plurality of reference regions, the reference regions at least comprising a third region and a fourth region, wherein the luma values of pixel points in the third region are greater than the luma values of pixel points in the fourth region,
a transformation matrix generation module, configured to obtain a transformation matrix for the first region based on color values of pixel points in the first region and color values of pixel points in the third region, and obtain a transformation matrix for the second region based on color values of pixel points in the second region and color values of pixel points in the fourth region, and
a processing module configured to color map the original image according to the transformation matrix for the first region and the transformation matrix for the second region to obtain a target image.

In some embodiments, the transformation matrix generation module is specifically configured to:
calculate a covariance matrix of color channel dimensions corresponding to each of the plurality of original regions, based on the color values of pixel points in the original region, calculate a covariance matrix of color channel dimensions corresponding to each of the plurality of reference regions, based on the color values of pixel points in the reference region, determine the transformation matrix for the first region based on the covariance matrix of the color channel dimensions corresponding to the first region and the covariance matrix of the color channel dimension corresponding to the third region, and determine the transformation matrix for the second region based on the covariance matrix of the color channel dimensions corresponding to the second region and the covariance matrix of the color channel dimension corresponding to the fourth region.

In some embodiments, the processing module is specifically configured to:
process the color values of pixel points in the original image according to the transformation matrix for the first region to obtain a first corrected image corresponding to the transformation matrix for the first region, process the color values of pixel points in the original image according to the transformation matrix for the second region to obtain a second corrected image corresponding to the transformation matrix for the second region; and fuse the first corrected image and the second corrected image to obtain the target image.

In some embodiments, the processing module is specifically configured to:
process the color values of the pixel points in the first region according to the transformation matrix for the first region to obtain a first corrected region corresponding to the first region, process the color values of the pixel points in the second region according to the transformation matrix for the second region to obtain a second corrected region corresponding to the second region, and stitch the first corrected region and the second corrected region to obtain the target image.

In some embodiments, the region division module is specifically configured to:
arrange the pixel points in the original image in order of the luma values from low to high to determine at least one first cutoff value, divide the pixel points in the original image into the plurality of original regions based on the at least one first cutoff value, arrange the pixel points in the reference image in order of the luma values from low to high to determine at least one second cutoff value, and divide the pixel points in the reference image into the plurality of reference regions based on the at least one second cutoff value.

In some embodiments, the plurality of original regions further comprise a fifth region, and the luma values of the pixel points in the fifth region are greater than the luma values of the pixel points in the first region, or, the luma values of the pixel points in the fifth region are smaller than the luma values of the pixel points in the second region,

the reference regions also comprise a sixth region, wherein the luma values of the pixel points in the sixth region are greater than the luma values of the pixel points in the third region, or the luma values of the pixel points in the sixth region are smaller than luma values of pixel points in the fourth region,

the transformation generation module is further configured to:
obtain a transformation matrix for the fifth region based on the color values of the pixel points in the fifth region and the color values of the pixel points in the sixth region,
the processing module is further configured to:
   color map the original image based on the transformation matrix for the first region, the transformation matrix for the second region and the transformation matrix for the fifth region, to obtain the target image.

According to a third aspect, the present disclosure further proposes a computing device, comprising: one or more processor, a memory, and one or more computer programs, wherein the one or more computer programs are stored in the memory, when the one or more processors execute the one or more computer programs, the computing device is caused to implement the image processing method in the first aspect as above.

An embodiment of the present disclosure provides a computer storage medium, including computer instructions, which, when running on an electronic device, cause the electronic device to execute the image processing method in the first aspect as above.

An embodiment of the present disclosure provides a computer program product, which, when running on a computer, causes the computer to execute the image processing method in the first aspect as above.

### DESCRIPTION OF THE DRAWINGS

The drawings herein are incorporated in and constitute a part of this specification, and these drawings illustrate some embodiments according to the present disclosure, and together with the description, serve to explain the technical solutions of the present disclosure.

In order to more clearly illustrate the technical solutions in the embodiments of the present disclosure or related technologies, the following will briefly introduce the drawings that need to be used in the descriptions of the embodiments or related technologies. Obviously, for those ordinary skilled in the art, other drawings can also be obtained from these drawings without any creative effort.

FIG. 1A is a schematic diagram of an original image;

FIG. 1B is a schematic diagram of a reference image;

FIG. 1C is a schematic diagram of a filter migration result;

FIG. 2 is a schematic flowchart of an image processing method provided by an embodiment of the present disclosure;

FIG. 3 is a schematic flowchart of another image processing method provided by an embodiment of the present disclosure;

FIG. 4 is a schematic flowchart of another image processing method provided by an embodiment of the present disclosure;

FIG. 5 is a schematic flowchart of another image processing method provided by an embodiment of the present disclosure;

FIG. 6 is a schematic flowchart of another image processing method provided by an embodiment of the present disclosure;

FIG. 7 shows a schematic structural diagram of an image processing device provided by an embodiment of the present disclosure.

### DETAILED DESCRIPTION OF PREFERRED EMBODIMENTS

In order to make the objectives, technical solutions and advantages of the embodiments of the present disclosure clearer, the technical solutions in the embodiments of the present disclosure will be further described below. It shall be noted that the embodiments and the features in the embodiments in the present disclosure can be combined with each other without conflict.

Some concrete details are illustrated in the following description for full understanding of the present disclosure, but the present disclosure can be implemented in any other manner than the manners described herein, it is obvious that the embodiments in the description are only a part of, instead of all, embodiments of the present disclosure.

In many scenarios, it is necessary to perform filter migration operations on images or videos by means of an electronic device. Filter migration refers to adjusting a color tone style of an original image/video according to the color tone style of a reference image/video, so that the color tone of the original image/video is consistent with the color tone of the reference image/video.

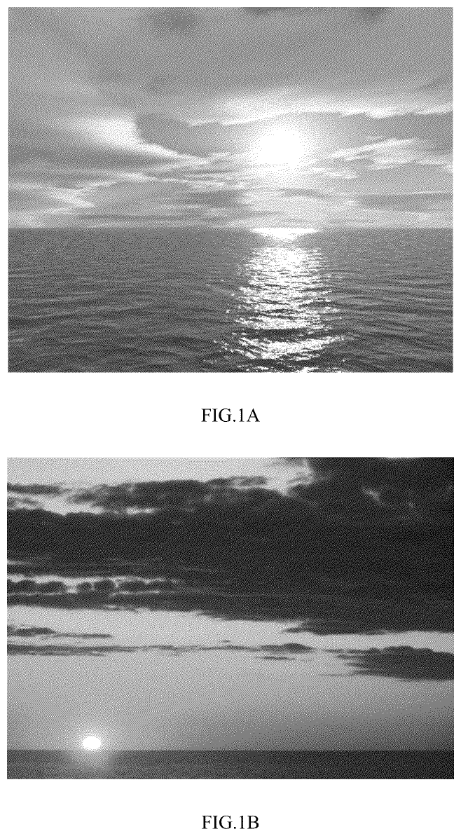

For image filter migration, it is necessary to adjust the color tone style of the original image according to the color tone style of the reference image, so that the color tones of the original image and the reference image are consistent. For example, in order to create a certain atmosphere, the color tone of the original image can be adjusted according to actual needs, or, when the color tones of a plurality of images are inconsistent, filter migration can be performed on the images in order to unify the color tones of a plurality of images. Refer to FIG. 1A, FIG. 1B and FIG. 1C, FIG. 1A is a schematic diagram of an original image, FIG. 1B is a schematic diagram of a reference image, and FIG. 1C is a schematic diagram of a filter migration result.

A video picture is composed of a plurality of frames of images. For video filter migration, similar to the image filter migration, the color tone style of each frame of the original image in the video is adjusted according to the color tone style of the reference image, so that each frame of the original image and the reference image have the consistent color tones. For example, in the process of film production or video editing, due to different shooting environment, shooting time and/or shooting ambient light for each video clip, there may exist a difference in color tone between respective video clips, and it is necessary to unify the color tones of these clips, so that these video clips look more natural after they are stitched together. In these cases, it is necessary to quickly unify the color tones of a plurality of video clips.

In the existing filter migration method, the histogram of each channel of the original image matches with the histogram of each channel of the reference image, so that the histogram of each channel of the original image is close to the reference image.

However, the effect of filter migration obtained in this way is not good.

The present disclosure provides an image processing method, by dividing the original image and the reference image into regions according to the luma values of the pixel points therein respectively, and for each corresponding region, obtaining a transformation matrix from the original image to the target image for the region based on the color values of the pixel points in the original image and the reference image, so as to obtain at least two transformation matrices based on different luma value regions, and obtaining the target image based on the at least two transformation matrices, so that the obtained target image is more natural, and the filter migration effect is good.

Specifically, compared with related technologies, the technical solutions provided by the embodiments of the present disclosure have the following advantages:
an original image is divided into a plurality of original regions, the plurality of original regions at least comprising a first region and a second region, wherein luma values of pixel points in the first region are greater than the luma values of pixel points in the second region, and a reference image is divided into into at least two reference regions, therefore, the original image and reference image can be divided into regions corresponding to one by one based on luma values of the original image and reference image respectively. A transformation matrix for the first region is obtained based on color values of pixel points in the first region and color values of pixel points in the third region, and a transformation matrix for the second region is obtained based on color values of pixel points in the second region and color values of pixel points in the fourth region, that is, different regions are processed individually, and the transformation matrix corresponding to each region can be obtained based on the color values, then, the original image is color mapped according to the transformation matrix for the first region and the transformation matrix for the second region to obtain a target image. The pixel points in the image are divided into regions according to the luma values, and the color values in each region are processed individually to obtain a transformation matrix, and the filter migration process is performed based on at least two transformation matrices obtained, so that the obtained target image is more natural, the target image is closer to the reference image in color tone, resulting in better filter migration.

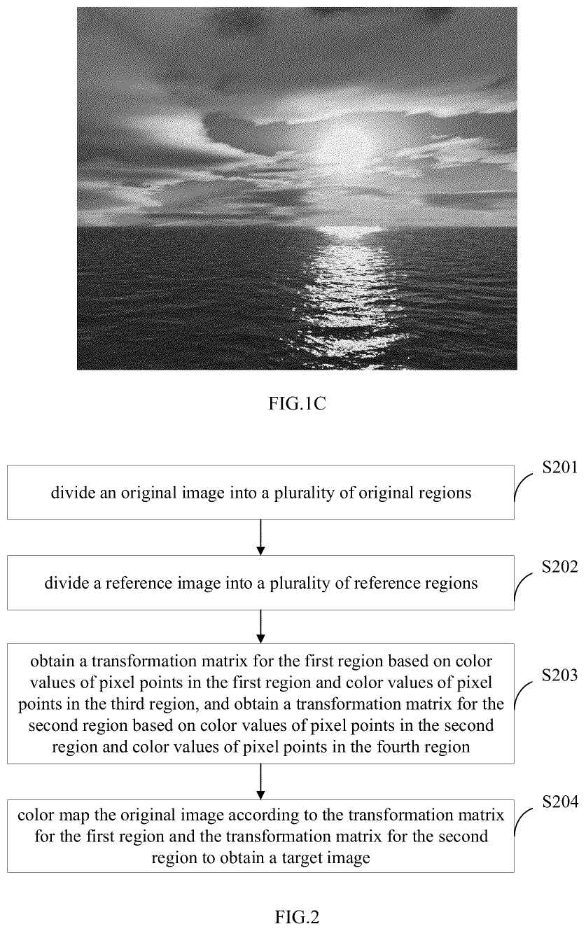

According to some embodiments of the present disclosure, FIG. 2 is a schematic flowchart of an image processing method provided by an embodiment of the present disclosure, as shown in FIG. 2, the method of this embodiment is executed by an electronic device, which may be a computer, a mobile phone, a tablet device, etc., the present disclosure does not limit this, the method of this embodiment is as follows:
S201. Divide an original image into a plurality of original regions.
Wherein, the plurality of original regions comprise at least a first region and a second region, and the luma values of the pixel points in the first region are greater than the luma values of the pixel points in the second region.
S202. Divide a reference image into a plurality of reference regions.
Wherein, the reference regions comprise at least a third region and a fourth region, wherein the luma values of the pixel points in the third region are greater than the luma values of the pixel points in the fourth region.

The original and reference images are acquired, and among them, it is necessary to migrate the filter for the reference image to the original image.

The color spaces of the original image and the reference image each contains a luma value channel and a color value channel, for example, the color space can be Lab, Luma-color difference (YUV) or luma-hue (Laβ) color space, etc., wherein, in the Lab color space, L represents luma: a represents a first parameter, and the range of a is +127 to −128, among them, a positive number represents red, and a negative value represents green: b represents a second parameter, and the range of b is +127 to −128, where positive numbers represent yellow and negative numbers represent blue. This disclosure does not limit it. In this embodiment, the YUV color space is taken as an example for illustration. The YUV color space includes three channels in total, namely Y channel, U channel and V channel, wherein the Y channel is the luma value channel, and the U channel and the V channel are the color value channels.

The color space of the reference image is the same as that of the original image. If the color space of the reference image is different from that of the original image, conversion is required so that the reference image and the original image are in the same color space.

In some embodiments, when the acquired original image is in a color space without a luma value channel, for example, the color space of the original image may be Red Green Blue (RGB for short) or Cyan Magenta Yellow Black (CMYK for short) and other color spaces, which are not limited in this disclosure. The original image can be firstly converted to a color space that includes a luma value channel and a color value channel. For example, it is required to perform processing in the YUV color space, and the original image can be converted from the RGB color space to the YUV color space, and then be subjected to subsequent processing.

In a case that the acquired reference image is in a color space without a luma value channel, for example, the color space of the reference image may be a color space such as RGB or CMYK, etc., which is not limited in the present disclosure. The reference image can be first converted to a color space that includes a luma value channel and a color value channel. For example, it is required to perform processing in the YUV color space, and the reference image can be converted from the RGB color space to the YUV color space, and then be subjected to subsequent processing.

The pixel points in the original image can be divided into regions according to the luma values of the pixel points in the original image, so as to obtain a plurality of original regions. For example, in the YUV color space, according to the luma value of the Y channel of the original image, the pixel points in the original image can be divided into regions, so that all the pixel points can be divided into a plurality of original regions.

Correspondingly, the pixel points in the reference image can be divided into regions according to the luma values of the pixel points in the reference image, so as to obtain a plurality of reference regions. For example, according to the luma value of the Y channel of the reference image, the pixel points in the reference image can be divided into regions, so that all the pixel points can be divided into a plurality of reference regions.

The number of obtained original regions is the same as that of the reference regions, and the original regions correspond to the reference regions one by one, and subsequently, the divided original regions and corresponding reference regions are subject to processing respectively. That is to say, for the original image, a plurality of original regions can be obtained according to the luma values of the pixel points and a preset rule: for the reference image, a plurality of reference regions can be obtained according to the luma values of the pixel points and a preset rule, and the above preset rules are the same, and the obtained original regions correspond to the reference region one by one. For example, the preset rule can be to arrange the pixel points in the image in order of the luma values from high to low, or from low to high, and then the regions are divided according to the order of arrangement. Therefore, the obtained original regions correspond to the reference regions one by one, that is, the first region corresponds to the third region, and the second region corresponds to the fourth region.

Assume that the preset rule is to divide an image into two regions according to the order of luma values from high to low, the pixel points corresponding to the first half of the luma values are divided into the first region, and the pixel points corresponding to the second half of the luma values are divided into the second region. That is, the higher of the position of a divided region is, the larger the luma values of the pixel points in the region are. Next, the original image and the reference image are processed according to preset rules. The pixel points in the original image are arranged in order of luma value from high to low, the pixel points corresponding to the first half of the luma values are divided into the first region, and the pixel points corresponding to the second half of the luma values are divided into the second region. Correspondingly, the pixel points in the reference image are arranged in order of luma value from high to low, the pixel points corresponding to the first half of the luma values are divided into the third region, and the pixel points corresponding to the second half of the luma values are divided into the third region. Then the first region corresponds to the third region, and the second region corresponds to the fourth region.

It can be understood that there is no sequence for execution of steps S201 and S202, S201 may be executed first and then S202 may be executed, or S202 may be executed first and then S201 may be executed, or S201 and S202 may be executed simultaneously, which is not limited in the present disclosure.

S203. obtain a transformation matrix for the first region based on color values of pixel points in the first region and color values of pixel points in the third region, and obtain a transformation matrix for the second region based on color values of pixel points in the second region and color values of pixel points in the fourth region.

Filter migration is a process of color mapping, that is, mapping the color of the original image to obtain the mapped color of the target image. The color of the target image can be obtained from a color mapping function and the color of the original image, namely v=T(u), where v is the color of the target image, u is the color of the original image, and T is the color mapping function. The colors of the reference image and the target image to be obtained are similar with each other. Therefore, the mapping function can be determined based on the color of the original image and the color of the reference image, so that the target image can be obtained and the filter migration can be implemented. Therefore, in order to obtain the target image, the mapping function needs to be determined first.

For each original region and the reference region corresponding to the original region, the transformation matrix for the original region is obtained based on the color values of the pixel points in the original region and the color values of the pixel points in the reference region. Wherein, the color values of pixel points in the original region are values of the pixel points in the original region in the color channels, and the color values of pixel points in the reference region are values of the pixel points in the reference region in the color channels.

Since the first region corresponds to the third region, and the second region corresponds to the fourth region, the transformation matrix for the first region is obtained based on the color values of the pixel points in the first region and the color values of the pixel points in the third region, and the transformation matrix for the second region is obtained based on the color values of the pixel points in the second region and the color values of the pixel points in the fourth region. Among them, the color values of the pixel points in the first region are values of the pixel points in the first region in the color channels. The color values of the pixel points in the second region are values of the pixel points in the second region in the color channels. The color values of the pixel points in the third region are values of the pixel points in the third region in the color channels. The color values of the pixel points in the fourth region are values of the pixel points in the fourth region in the color channels.

Taking the original image and the reference image in the YUV color space as an example, the color values of the pixel points in a certain region are values of all the pixel points in the region in the U channel and the V channel. For example, the color values of the pixel points in the first region are the values of all the pixel points in the first region in the U channel and the V channel.

In a case where there are two or more color channels in the color spaces to which the original image and the reference image belong, in a possible implementation, the number of the obtained transformation matrix for each original region may be one. For example, covariance transformation matrices for at least two color channels corresponding to pixel points in the original region may be obtained.

In another possible implementation, for each color channel in each original region, a transformation matrix corresponding to each color channel may be obtained, and the number of transformation matrices in the original region is the same as the number of color channels. For example, a standard deviation is obtained for each color channel.

S204. color map the original image according to the transformation matrix for the first region and the transformation matrix for the second region to obtain a target image.

Color mapping is performed on the color channels of the original image according to the transformation matricies for respective original regions to obtain respective color mapping results, and the target image is obtained by fusing respective color mapping results with the luma values of the original image. That is, color mapping is performed on the original image according to the transformation matrix for the first region and the transformation matrix for the second region, respectively, so as to obtain two color mapping results, and the two color mapping results are fused with the luma values of the original image to obtain the target image.

Further, in a possible implementation of obtaining respective color transformation results, each color transformation result may be obtained according to the transformation matrix for each original region, the color average value of each original region and the color average value of each reference region. Among them, the color average value of the original region is the average of the color values of all pixel points in the original region. The color average value of the reference region is the average of the color values of all pixel points in the reference region. The color average value is an average calculated separately for each color channel. Taking the YUV color space as an example, the color average value comprises the average of the values of the U channel and the average of the values of the V channel.

Further, in a possible implementation of obtaining the target image by fusing respective color transformation results with the luma value of the original image, the color value of the target image can be obtained based on all obtained color transformation results, and the color value of each pixel point can be fused with the luma value of the corresponding original image to obtain the target image.

In some embodiments, if the original image is in a color space without a luma value channel before the above image processing steps, then before processing the original image, it is necessary to convert the original image to a color space that includes a luma value channel and a color channel, and then the original image is processed, the color space of the obtained target image is different from the color space of the original image, and the color space of the target image needs to be converted to the color space of the original image before the above image processing steps.

For example, the original image is in RGB color space, and before performing the above image processing steps, the original image is converted from RGB color space to YUV color space, so that through the above image processing steps, the target image obtained is in YUV color space, and the target image is converted from YUV color space to RGB color space to obtain the final target image.

In this embodiment, the original image is divided into a plurality of original regions, the plurality of original regions at least comprising a first region and a second region, wherein luma values of pixel points in the first region are greater than the luma values of pixel points in the second region, and a reference image is divided into into at least two reference regions, therefore, the original image and reference image can be divided into regions corresponding to one by one based on luma values of the original image and reference image respectively. A transformation matrix for the first region is obtained based on color values of pixel points in the first region and color values of pixel points in the third region, and a transformation matrix for the second region is obtained based on color values of pixel points in the second region and color values of pixel points in the fourth region, that is, different regions are processed individually, and the transformation matrix corresponding to each region can be obtained based on the color values, then, the original image is color mapped according to the transformation matrix for the first region and the transformation matrix for the second region to obtain a target image. The pixel points in the image are divided into regions according to the luma values, and the color values in each region are processed individually to obtain a transformation matrix, and the filter migration process is performed based on at least two transformation matrices obtained, so that the obtained target image is more natural, the target image is closer to the reference image in color tone, resulting in better filter migration.

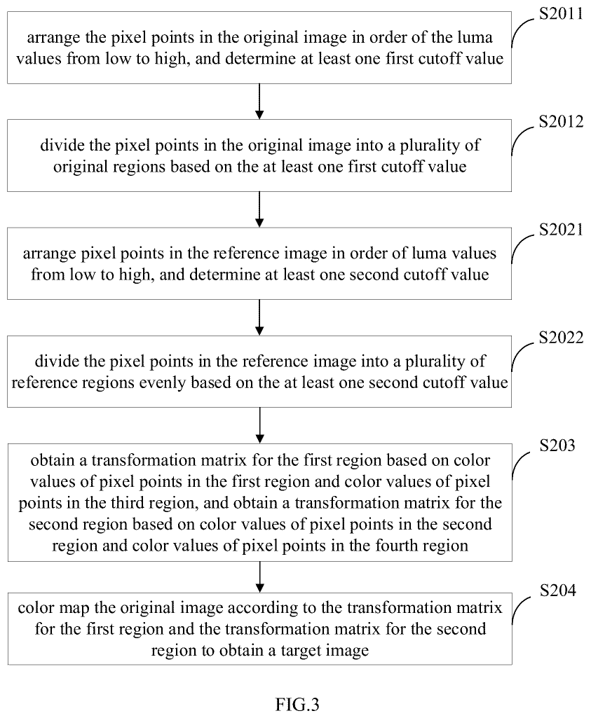

Further, on the basis of the embodiment shown in FIG. 2, a possible implementation of S201 and S202 can be to arrange the pixel points in order of the luma values from low to high, determine the cutoff value for the region division, and then divide the regions based on the cutoff value, referring to FIG. 3, which is a schematic flowchart of another image processing method provided by the embodiment of the present disclosure, FIG. 3 is based on the embodiment shown in FIGS. 2, S2011 and S2012 belong to a specific implementation of S201, and correspondingly, S2021 and 2022 belong to a specific implementation of S202:
S2011. Arrange the pixel points in the original image in order of the luma values from low to high, and determine at least one first cutoff value.
S2012. Divide the pixel points in the original image into a plurality of original regions based on the at least one first cutoff value.

Each pixel point in the original image corresponds to a luma value, and these luma values can be obtained, arranged in order of the luma values from low to high to form a sequence of luma values, and at least one first cutoff value is determined according to a preset value selection rule.

Among them, the preset value selection rule is to obtain a first cutoff value every preset number of luma values. Exemplarily, the preset value selection rule can obtain a first cutoff value for every same number of luma values, and the first cutoff values divides the sequence of luma values evenly, and if the total number of pixel points cannot be completely evenly divided, then a pixel point corresponding to the first cutoff value can be arranged into its two adjacent original regions, or into one of the two adjacent original regions, which is not limited in the present disclosure.

For example, if the obtained luma values of pixel points in the original image are 20, 30, 50, 200, 50, 150, 150, 210, and 160, they are first arranged in order from low to high, and the obtained luma value sequence is: 20, 30, 50, 50, 150, 150, 160, 200, 210, if it is assumed that the pixel points are intended to be evenly divided into two orignal regions in accordance with luma values, then the first cutoff value can be taken as 150, since the total number of pixel points is 9, dividing into two original regions cannot implement complete even division. Therefore, the original regions divided according to the first cutoff value can comprises a second region comprising pixel points of 20, 30, 50, 50, and a first region comprising pixel points of 150, 150, 160, 200, 210. Alternatively, it can be a case that the second region comprises pixel points of 20, 30, 50, 50, 150, and the first region comprises pixel points of 150, 160, 200, 210, where two pixel points with luma value of 150 are arranged into the first region and the second region, and which one is arranged into the first region is not disclosed and is not limited.

S2021. Arrange pixel points in the reference image in order of luma values from low to high, and determine at least one second cutoff value.

S2022. Divide the pixel points in the reference image into a plurality of reference regions evenly based on the at least one second cutoff value.

Steps S2021-S2022 are similar to the above-mentioned steps S2011-S2012, and will not be repeated here.

It should be noted that the numbers of the first cutoff value and the second cutoff value are equal. The preset value selection rules for obtaining the first cutoff value and the second cutoff value are the same.

In this embodiment, when the original image and the reference image are divided into regions, the luma values of the respective pixel points are arranged in order from low to high, the same number of cutoff values are determined, and then the regions are divided based on the cutoff values. Since the number of the first cutoff values and the second cutoff values are equal, the number of the original regions and the reference regions are equal, and the cutoff values obtained by arranging the luma values in order from low to high are used for region division, so that the original regions of the original image correspond to the reference regions of the reference image one by one so as to facilitate subsequent processing, so that the target image is more natural and is closer to the reference image in color tone, and the filter migration effect is better.

On the basis of the embodiment in FIG. 3, further, in this embodiment, that the number of the first cutoff values and the number of the second cutoff values both are two, that is, the original image and the reference image each is divided into three regions are taken as an example for further illustration.

A specific implementation of step S2011 is: arrange the pixel points in the original image in order of the luma values from low to high, and determine two first cutoff values.

Correspondingly, a specific implementation of S2012 is: divide the pixel points into three original regions based on the two first cutoff values.

That is to say, in addition to the first region and the second region, the original regions also include a fifth region, wherein the luma values of the pixel points in the fifth region are greater than the luma values of the pixel points in the first region, or the luma values of the pixel points in the fifth region are smaller than the luma values of the pixel points in the second region.

Taking the YUV color space as an example, the Y channel is the luma value channel, and the cumulative distribution of the luma values of the pixel points of the original image in the Y channel can be made statistics, thereby determining two first cutoff values, and three original regions can be obtained.

For example, the luma value corresponding to the first ⅓ of the cumulative distribution of luma values of the pixel points is used as the first cutoff point between dark part and midtone, and the luma value corresponding to the first ⅔ is used as the first cutoff point between midtone and highlight. By using the above two first cutoff points, the pixel points in the original image are divided into three original regions.

The luma of the pixel points contained in the first original region of the three original regions is relatively lowest, and can be called as an original dark region; the luma of the pixel points contained in the second original region is higher than that of the first original region, and can be called as an original midtone region: the luma of the pixel points contained in the third original region is relatively highest, which can be called as an original highlight region.

A specific implementation of step S2021 is: arrange the pixel points in the reference image in order of the luma values from low to high, and determine two second cutoff values.

Correspondingly, a specific implementation of S2022 is: divide the pixel points into three reference regions based on the two first cutoff values.

That is to say, in addition to the third region and the fourth region, the reference regions also include a sixth region, wherein the luma values of the pixel points in the sixth region are greater than the luma values of the pixel points in the third region, or the luma values of the pixel points in the sixth region are smaller than the luma values of the pixel points in the fourth region.

It should be noted that the sixth region corresponds to the fifth region. If the luma values of the pixel points in the fifth region are greater than the luma values of the pixel points in the first region, then the luma values of the pixel points in the sixth region are greater than the luma values of the pixel points in the third region. If the luma values of the pixel points in the fifth region are smaller than the luma values of the pixel points in the second region, then the luma values of the pixel points in the sixth region are smaller than the luma values of the pixel points in the fourth region.

Taking the YUV color space as an example, the cumulative distribution of the luma values of the pixel points of the reference image in the Y channel can be made statistics, thereby determining two second cutoff values, and three original regions can be obtained based on such two second cutoff values.

For example, the luma value corresponding to the first ⅓ of the cumulative distribution of luma values of the pixel points is used as the second cutoff point between dark part and midtone, and the luma value corresponding to the first ⅔ is used as the second cutoff point between midtone and highlight. By using the above two second cutoff points, the pixel points are divided into three reference regions. The luma of the pixel points contained in the first reference region of the three reference regions is relatively lowest, and can be called as a reference dark region: the luma of the pixel points contained in the second reference region is higher than that of the first reference region, and can be called as a reference midtone region; the luma of the pixel points contained in the third reference region is relatively highest, which can be called as a reference highlight region.

Among them, the original dark region corresponds to the reference dark region, the original midtone region corresponds to the reference midtone region, and the original highlight region corresponds to the reference highlight region.

Therefore, on the basis of the above-mentioned embodiment method, the method of the present embodiment further comprises the following steps:
obtaining a transformation matrix for the fifth region, based on the color values of the pixel points in the fifth region and the color values of the pixel points in the sixth region.

Since the fifth region corresponds to the sixth region, the transformation matrix for the fifth region can be obtained by using a method similar to that of obtaining the transformation matrix for the first region.

Correspondingly, a specific implementation of S204 is:

The color mapping is performed on the original image, based on the transformation matrix for the first region, the transformation matrix for the second region and the transformation matrix of the fifth region, to obtain the target image.

Therefore, the color mapping is performed on the original image, based on the transformation matricies corresponding to the first region, the second region and the fifth region respectively, to obtain the target image.

In this embodiment, the original image is divided into three regions, and the reference image is divided into three regions, so that in the case of dividing into three regions, a transformation matrix corresponding to each region is respectively obtained, thereby obtaining the target image. If the region is divided more, the filter migration effect for the target image will be better, but the corresponding calculation load will also increase. Therefore, dividing into three regions can not only make the calculation load moderate, but also achieve better filter migration effect.

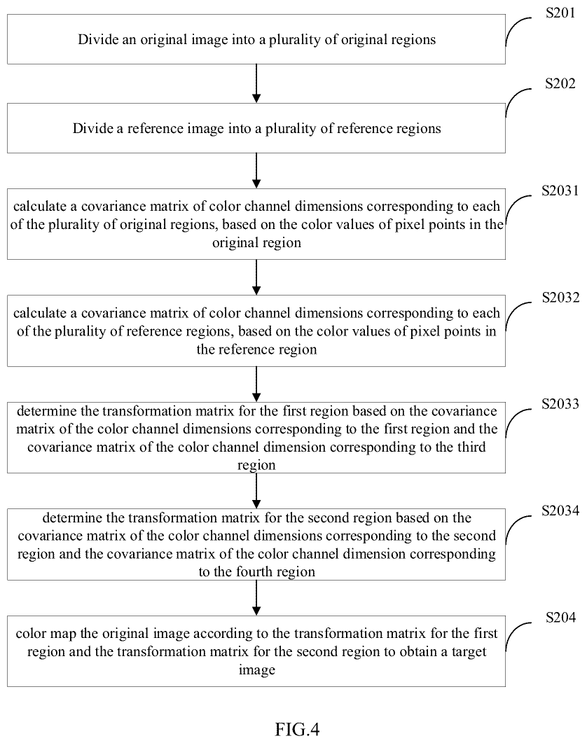

On the basis of the above embodiments, in an implementation of S203, the transformation matrix can be determined by calculating a covariance matrix, with reference to FIG. 4, which is a schematic flowchart of another image processing method provided by the embodiment of the present disclosure, FIG. 4 is based on the embodiment shown in FIG. 2 or FIG. 3, S2031-S2034 belong to a specific implementation of S203:
S2031. calculating a covariance matrix of color channel dimensions corresponding to each of the plurality of original regions, based on the color values of pixel points in the original region.
S2032. calculating a covariance matrix of color channel dimensions corresponding to each of the plurality of reference regions, based on the color values of pixel points in the reference region.

In the color spaces to which the original image and the reference image belong, there are two or more color channels, and the covariance matrix of the color channel dimensions corresponding to each of the plurality of original regions is calculated, wherein the covariance matrix of the color channel dimensions comprises a covariance matrix calculated by taking the color channels contained in the color space as dimensions.

For example, taking the YUV color space as an example, the value of U channel and the value of V channel of each pixel point in the first region are formed as a two-dimensional variable, and the color values of all pixel points in the first region can be regarded as a series of two-dimensional variables, and can be used for calculating the covariance matrix corresponding to the first region. It can be understood that the two dimensions of the two-dimensional variable are U channel and V channel respectively, and the covariance matrix is a 2×2 matrix. Then a 2×2 covariance matrix can be obtained for each original region. Correspondingly, the values of U channel and the values of V channel of the pixel points in the third region are formed as a series of two-dimensional variables, and are used for calculating the covariance matrix corresponding to the third region. It can be understood that the two dimensions of the two-dimensional variables are U channel and V channel respectively, the covariance matrix is a 2×2 matrix. Then a 2×2 covariance matrix can be obtained for each reference region.

It should be noted that there is no order for the execution of steps S2031 and S2032, S2031 can be executed first, and then S2032 can be executed, or S2032 can be executed first, and then S2031 can be executed, or S2031 and S2032 can be executed concurrently, which is not limited in this disclosure.

S2033. determining the transformation matrix for the first region based on the covariance matrix of the color channel dimensions corresponding to the first region and the covariance matrix of the color channel dimension corresponding to the third region.

S2034. determining the transformation matrix for the second region based on the covariance matrix of the color channel dimensions corresponding to the second region and the covariance matrix of the color channel dimension corresponding to the fourth region.

As can be seen from the embodiment shown in FIG. 2, the color v of the target image can be obtained based on a color mapping function T and the color u of the original image, that is, v=T(u), where the mapping function T needs to be determined here, then the color v of the target image can be obtained. Since a linear function is sufficient to fit the color mapping situation, and the solution to the linear function is relatively simple and the computational complexity is low, the mapping function T can be a linear function, that is, the color v of the target image can be expressed as v=a* u+b, where a and b are parameters, and the color u of the original image can be converted into the color v of the target image by a linear transformation T. According to the mathematical theory of linear transformation, if there is a linear transformation between two variables, the linear transformation is configured with a covariance matrix applicable to two variables. Since the color style of the target image is similar to that of the reference image, the covariance matrix for the original image, after subject to linear transformation T, is equal to the covariance matrix for the reference image, and the mapping function can be obtained based on the covariance matrix for the original image and the covariance matrix for the reference image.

Therefore, for each original region obtained above and its corresponding reference region, a transformation matrix can be obtained. That is, for the covariance matrix of the color channel dimensions of each original region and the covariance matrix of the color channel dimensions of the reference region corresponding to the original region, the transformation matrix for the original region can be obtained. It can be understood that since the first region corresponds to the third region and the second region corresponds to the fourth region, based on the covariance matrix of the color channel dimensions corresponding to the first region and the covariance matrix of the color channel dimensions corresponding to the third region, a transformation matrix for the first region is determined. Based on the covariance matrix of the color channel dimensions corresponding to the second region and the covariance matrix of the color channel dimensions corresponding to the fourth region, the transformation matrix for the second region is determined.

Taking the YUV color space as an example, the transformation matricies for the corresponding regions of the original image and the reference image are the transformation matricies of the color channel dimensions (that is, the U channel and V channel dimensions), and for each original region and its corresponding reference region, the transformation matricies therebetween for the U channel and for the V channel can be calculated respectively, so as to obtain the color mapping function.

For example, Monge-Kantorovitch can be used as a solution method, the covariance matrix for the original region is Σ_u, the covariance matrix for the reference region corresponding to the original region is Σ_v, and the transformation matrix T can be obtained by the following formula (1):

$$T = {\sum }_{u}^{- 1 / 2} {( {\sum }_{u}^{1 / 2} {\sum }_{v} {\sum }_{u}^{1 / 2} )}^{1 / 2} {\sum }_{u}^{1 / 2} \qquad formula ( 1 )$$

Among them, u is the covariance matrix for the original region, and v is the covariance matrix for the reference region.

In this embodiment, by calculating a covariance matrix of color channel dimensions corresponding to each of the plurality of original regions based on the color values of pixel points in the original region, calculating a covariance matrix of color channel dimensions corresponding to each of the plurality of reference regions based on the color values of pixel points in the reference region, determining the transformation matrix for the first region based on the covariance matrix of the color channel dimensions corresponding to the first region and the covariance matrix of the color channel dimension corresponding to the third region, and determining the transformation matrix for the second region based on the covariance matrix of the color channel dimensions corresponding to the second region and the covariance matrix of the color channel dimension corresponding to the fourth region, that is, for the covariance matrix corresponding to each original region and its corresponding reference region respectively, the transformation matrix can be obtained, since the covariance matrix can reflect the correlation between the color channels, the transition between the color channels of the target image finally obtained according to the covariance matrix is more natural, and the color tone of the target image is close to the reference image, so that the filter migration can be realized.

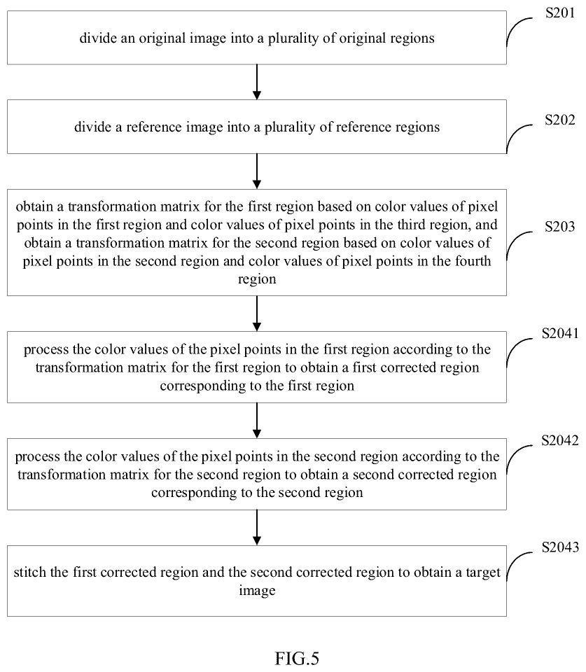

On the basis of the above embodiments, further, in a possible implementation of step S204, each original region can be processed separately, and the pixel points in the original region are processed according to the transformation matrix for the original region to obtain the corrected regions corresponding to the original region, and then the corrected regions corresponding to respective original regions can be stitched together to obtain the target image, referring to FIG. 5, FIG. 5 is a schematic flowchart of another image processing method provided by the embodiment of the present disclosure, S2041-S2043 belongs to a specific implementation manner of S204, which will be described in detail below.

S2041. processing the color values of the pixel points in the first region according to the transformation matrix for the first region to obtain a first corrected region corresponding to the first region.

S2042. processing the color values of the pixel points in the second region according to the transformation matrix for the second region to obtain a second corrected region corresponding to the second region.

Each original region can be processed separately, and the color values of pixel points in the original region are processed according to the transformation matrix for the original region to obtain the corrected regions corresponding to the original region, and then the corrected regions corresponding to respective original regions can be obtained.

Further, for each original region, the color values of the pixel points in the original region are processed based on the color average value of the original region and the color average value of the reference region corresponding to the original region, to obtain the corrected region corresponding to the original region. Among them, the corrected region corresponding to the original region comprises the target color value corresponding to each pixel point in the original region. Taking the YUV color space as an example, the corrected region of the original region comprises the target value of the U channel and the target value of the V channel corresponding to each pixel point in the original region.

In a possible implementation, for each original region, the corrected region corresponding to the original region can be obtained through the following steps 1-3:
Step 1. Subtracting the color average value of the original region from the color value of each pixel in the original region to obtain a zero-removed result.
Step 2. Processing the zero-removed result based on the transformation matrix for the original region, to obtain the transformation result.
Step 3: Adding the color average value of the reference region to the transformation result, to obtain the corrected region corresponding to the original region.

In another possible implementation, the above steps 1-3 can be regarded as the operations of translating, rotating-zooming, and translating the vector of the color dimensions sequentially. Therefore, based on the transformation matrix for the original region, the color average value of the original region and the color average of the reference region, a whole transformation matrix can be obtained. The color values of the pixel points in the original region are processed based on the whole transformation matrix, to obtain the corrected region corresponding to the original region.

S2043. Stitching the first corrected region and the second corrected region to obtain a target image.

The corrected regions corresponding to all of the original regions are stitched to obtain the color result of the target image. The target image can be obtained by fusing the color result of the target image with the luma value of the original image.

All the corrected regions corresponding to the original regions are stitched according to the positions of their pixel points in the original image to obtain the color result of the target image. Among them, the color result of the target image comprises the target color value corresponding to each pixel of the target image. Taking the YUV color space as an example, the color result of the target image comprises the target value of the U channel and the target value of the V channel corresponding to each pixel in the target image.

Since the filter migration converts the color, the luma values of the pixel points of the original image have not been changed in the previous steps, therefore, after the color result of the target image is obtained, the color result of the target image and the luma values of the pixel points of the original image are fused to obtain a complete target image.

In this embodiment, by separately processing the color values of the pixel points in each original region to obtain the corrected region of the original region, and then stitching the corrected regions of respective original regions together, so that the target image is obtained, and each original region is processed by means of the transformation matrix of for the original region, so that the corrected region obtained from each original region is more accurate, the target image is closer to the reference image, and the filter migration effect is better.

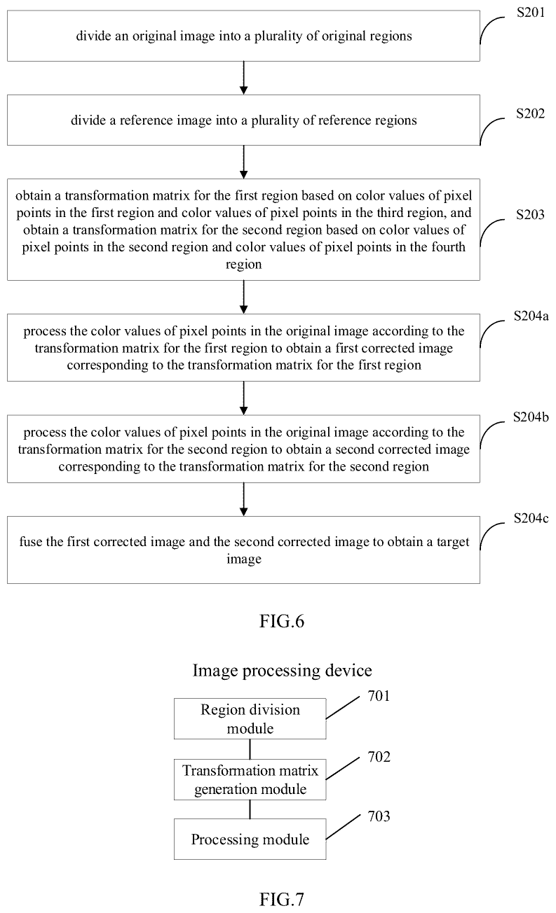

On the basis of the above embodiments, further, in another possible implementation of step S204, all pixel points of the original image are processed based on the transformation matrix for the original region, the color average value of the original region, and the color average value of the reference region corresponding to the original region, to obtain the color transformation result corresponding to the transformation matrix, and the average value of all the color transformation results is calculated to obtain the target image, referring to FIG. 6, which is a schematic flowchat of another image processing method provided by the embodiment of the present disclosure. S204a-S204c is a specific implementation of S204:
S204a. processing the color values of pixel points in the original image according to the transformation matrix for the first region to obtain a first corrected image corresponding to the transformation matrix for the first region.
S204b. processing the color values of pixel points in the original image according to the transformation matrix for the second region to obtain a second corrected image corresponding to the transformation matrix for the second region.

For the transformation matrix for each original region, the color value of each pixel point in the original image may be processed according to the transformation matrix of the original region to obtain a corrected image corresponding to the transformation matrix. Therefore, the corrected image corresponding to each transformation matrix is obtained.

Further, for each original region, the color value of each pixel in the original image is processed based on the color average value of the original region and the color average value of the reference region corresponding to the original region. As a result, corrected images whose number is equal to the number of original regions can be obtained. Among them, the corrected image corresponding to the transformation matrix comprises the matching color value corresponding to each pixel point in the original image. Each pixel point in the original image can obtain at least two matching color values, and the number of matching color values is equal to the number of original regions. Taking the YUV color space as an example, the corrected image corresponding to the transformation matrix of the original region is the matching color value of the U channel and the matching color value of the V channel corresponding to each pixel point in the original image.

In a possible implementation, for the transformation matrix for each original region, the corrected image corresponding to the transformation matrix can be obtained through the following steps a-c:
Step a, Subtracting the color average value of the original region from color values of pixel points of the original image to obtain the zero-removed result.
Step b, Processing the zero-removed result based on the transformation matrix of the original region to obtain a transformation result.
Step c, Adding the transformation result to the color average value of the reference region to obtain a corrected image corresponding to the transformation matrix.

In another possible implementation, the above steps a-c can be regarded as the operations of translating, rotating-zooming, and translating the vector of the color dimensions sequentially. Therefore, based on the transformation matricies for respective original regions, the color average values of respective original regions, and the color averages of respective reference regions corresponding to the original regions, a whole transformation matrix corresponding to respective transform matricies can be obtained. The orignal image is processed based on the whole transformation matrix corresponding to respective transformation matricies, to obtain the corrected image corresponding to the transformation matrix.

S204c. Fusing the first corrected image and the second corrected image to obtain a target image.

The color values of each pixel point in the original image within respective corrected images are fused to obtain the target value of each pixel point, which is the value of the target image.

Further, the average value of the corrected images corresponding to the transformation matrices for all the original regions can be calculated to obtain the target image. As an example, the average value of the color values of each pixel point in all corrected images may be calculated respectively, to obtain the color result of the target image. The average value is the target color value of the pixel point in the target image. In this way, the target color values corresponding to all the pixel points of the target image can be obtained, that is, the color result of the target image is obtained.

Since the filter migration converts the color, the luma values of the pixel points of the original image have not been changed in the previous steps, therefore, the color result of the target image and the luma values of the pixel points of the original image are fused to obtain the target image.

In this embodiment, the first corrected image corresponding to the transformation matrix for the first region is obtained by processing the color values of the pixel points in the original image according to the transformation matrix for the first region, and the second corrected image corresponding to the transformation matrix for the second region is obtainted by processing the color values of the pixel points in the original image according to the transformation matrix for the second region, that is, according to the transformation matrix for each original region, all the pixel points of the original image are processed respectively to obtain the corrected images for the plurality of original images, and then all the corrected images are fused to obtain the target image, so that the transition between pixel points of different luma in the obtained target image is more natural, so that the target image is more natural.

On the basis of the above-mentioned embodiments, further, if it is necessary to perform a filter migration operation on the original video according to the color tone style of the reference video or the reference image, each frame of image contained in the original video is regarded as an original image, the above image processing method is carried out for the original image and a reference image to obtain the target image, and according to the position of the original images in the video, the target images can be composed into a frame of the target video.

In some embodiments, if the original video belongs to the same scene, that is, the scene between each frame of original image of the original video is unchanged, the target image can be obtained from the first frame of original image of the original image by the method of the above-mentioned embodiment, and starting from the second frame of the original image of the orignal image, steps S201-S203 are not perfromed, that is, it is not necessary to calculate the transformation matrix corresponding to each original region of the frame of original image, and in step S204, the transformation matrix for each original region can be obtained from the first frame image of the original video and the reference image.

The filter migration performed on the video is carried out by GPU in an electronic device, and it takes less than 2 ms per frame for 720P video, which greatly improves the efficiency of video filter migration.

FIG. 7 is a schematic structural diagram of an image processing device provided by an embodiment of the present disclosure. As shown in FIG. 7, the device provided by this embodiment includes:
a region division module 701, configured to divide an original image into a plurality of original regions, the plurality of original regions at least comprising a first region and a second region, wherein luma values of pixel points in the first region are greater than the luma values of pixel points in the second region, and divide a reference image into into a plurality of reference regions, the reference regions at least comprising a third region and a fourth region, wherein the luma values of pixel points in the third region are greater than the luma values of pixel points in the fourth region,
a transformation matrix generation module 702, configured to obtain a transformation matrix for the first region based on color values of pixel points in the first region and color values of pixel points in the third region, and obtain a transformation matrix for the second region based on color values of pixel points in the second region and color values of pixel points in the fourth region, and
a processing module 703, configured to color map the original image according to the transformation matrix for the first region and the transformation matrix for the second region to obtain a target image.

In some embodiments, the transformation matrix generation module 702 is specifically configured to:
calculate a covariance matrix of color channel dimensions corresponding to each of the plurality of original regions, based on the color values of pixel points in the original region, calculate a covariance matrix of color channel dimensions corresponding to each of the plurality of reference regions, based on the color values of pixel points in the reference region, determine the transformation matrix for the first region based on the covariance matrix of the color channel dimensions corresponding to the first region and the covariance matrix of the color channel dimension corresponding to the third region, and determine the transformation matrix for the second region based on the covariance matrix of the color channel dimensions corresponding to the second region and the covariance matrix of the color channel dimension corresponding to the fourth region.

In some embodiments, the processing module 703 is specifically configured to:
process the color values of pixel points in the original image according to the transformation matrix for the first region to obtain a first corrected image corresponding to the transformation matrix for the first region, process the color values of pixel points in the original image according to the transformation matrix for the second region to obtain a second corrected image corresponding to the transformation matrix for the second region; and fuse the first corrected image and the second corrected image to obtain the target image.

In some embodiments, the processing module 703 is specifically configured to:
process the color values of the pixel points in the first region according to the transformation matrix for the first region to obtain a first corrected region corresponding to the first region, process the color values of the pixel points in the second region according to the transformation matrix for the second region to obtain a second corrected region corresponding to the second region, and stitch the first corrected region and the second corrected region to obtain the target image.

In some embodiments, the region division module 701 is specifically configured to:
Arrange the pixel points in the original image in order of the luma values from low to high to determine at least one first cutoff value, divide the pixel points in the original image into the plurality of original regions based on the at least one first cutoff value, arrange the pixel points in the reference image in order of the luma values from low to high to determine at least one second cutoff value, and divide the pixel points in the reference image into the plurality of reference regions based on the at least one second cutoff value.

In some embodiments, the plurality of original regions further comprise a fifth region, and the luma values of the pixel points in the fifth region are greater than the luma values of the pixel points in the first region, or, the luma values of the pixel points in the fifth region are smaller than the luma values of the pixel points in the second region,

the reference regions also comprise a sixth region, wherein the luma values of the pixel points in the sixth region are greater than the luma values of the pixel points in the third region, or the luma values of the pixel points in the sixth region are smaller than luma values of pixel points in the fourth region,

the transformation generation module 702 is further configured to:
obtain a transformation matrix for the fifth region based on the color values of the pixel points in the fifth region and the color values of the pixel points in the sixth region, the processing module 703 is further configured to:
color map the original image based on the transformation matrix for the first region, the transformation matrix for the second region and the transformation matrix for the fifth region, to obtain the target image.

The device in the above embodiments can be used to implement the technical solutions of the above method embodiments, and the implementation principles and technical effects thereof are similar, and will not be repeated here.

An embodiment of the present disclosure provides an electronic device, including: one or more processor, a memory, and one or more computer programs, wherein the one or more computer programs are stored in the memory, when the one or more processors execute the one or more computer programs, the computing device is caused to implement the image processing method of any one of the embodiments shown in FIGS. 2-6 above.

An embodiment of the present disclosure provides a computer storage medium, including computer instructions, which, when running on an electronic device, cause the electronic device to execute the image processing method in any of the above-mentioned embodiments shown in FIGS. 2-6 above.

An embodiment of the present disclosure provides a computer program product, which, when running on a computer, causes the computer to execute the image processing method in any of the above embodiments shown in FIGS. 2-6 above.

It should be noted that in this article, relative terms such as “first” and “second” are only used to distinguish one entity or operation from another entity or operation, and do not necessarily require or imply such actual relationship or order exists between such entities or operations. Furthermore, the term “comprises”, “comprising” or any other variation thereof is intended to cover a non-exclusive inclusion such that a process, method, article, or apparatus comprising a set of elements not only includes those elements, but also includes elements not expressly listed, even other elements inherent in such a process, method, article, or apparatus. Without further limitations, an element defined by the phrase “comprising a . . . ” does not preclude that in addition to the element, additional identical elements are presented in the process, method, article, or device.

The above are only specific implementation manners of the present disclosure, so that those skilled in the art can understand or implement the present disclosure. Various modifications to these embodiments will be readily apparent to those skilled in the art, and the general principles defined herein may be implemented in other embodiments without departing from the spirit or scope of the present disclosure. Therefore, the present disclosure will not be limited to these embodiments herein, but will conform to the widest scope consistent with the principles and novel features disclosed herein.

1. An image processing method, comprising:
dividing an original image into a plurality of original regions, the plurality of original regions at least comprising a first region and a second region, wherein luma values of pixel points in the first region are greater than the luma values of pixel points in the second region,
dividing a reference image into inte a plurality of reference regions, the reference regions at least comprising a third region and a fourth region, wherein the luma values of pixel points in the third region are greater than the luma values of pixel points in the fourth region,
obtaining a transformation matrix for the first region based on color values of pixel points in the first region and color values of pixel points in the third region, and obtaining a transformation matrix for the second region based on color values of pixel points in the second region and color values of pixel points in the fourth region, and
color mapping the original image according to the transformation matrix for the first region and the transformation matrix for the second region to obtain a target image.

2. The method of claim 1, wherein the obtaining a transformation matrix for the first region based on color values of pixel points in the first region and color values of pixel points in the third region, and obtaining a transformation matrix for the second region based on color values of pixel points in the second region and color values of pixel points in the fourth region, comprising:
calculating a covariance matrix of color channel dimensions corresponding to each of the plurality of original regions, based on the color values of pixel points in the original region;
calculating a covariance matrix of color channel dimensions corresponding to each of the plurality of reference regions, based on the color values of pixel points in the reference region;
determining the transformation matrix for the first region based on the covariance matrix of the color channel dimensions corresponding to the first region and the covariance matrix of the color channel dimension corresponding to the third region; and
determining the transformation matrix for the second region based on the covariance matrix of the color channel dimensions corresponding to the second region and the covariance matrix of the color channel dimension corresponding to the fourth region.

3. The method of claim 1, wherein, the color mapping the original image according to the transformation matrix for the first region and the transformation matrix for the second region to obtain a target image, comprising:
processing the color values of pixel points in the original image according to the transformation matrix for the first region to obtain a first corrected image corresponding to the transformation matrix for the first region;
processing the color values of pixel points in the original image according to the transformation matrix for the second region to obtain a second corrected image corresponding to the transformation matrix for the second region; and
fusing the first corrected image and the second corrected image to obtain the target image.

4. The method of claim 1, wherein the color mapping the original image according to the transformation matrix for the first region and the transformation matrix for the second region to obtain a target image, comprising:
processing the color values of the pixel points in the first region according to the transformation matrix for the first region to obtain a first corrected region corresponding to the first region;
processing the color values of the pixel points in the second region according to the transformation matrix for the second region to obtain a second corrected region corresponding to the second region; and
stitching the first corrected region and the second corrected region to obtain the target image.

5. The method of claim 1, wherein the dividing the original image into the plurality of original regions, comprising:
arranging the pixel points in the original image in order of the luma values from low to high to determine at least one first cutoff value;
dividing the pixel points in the original image into the plurality of original regions based on the at least one first cutoff value;
the dividing the reference image into the plurality of reference regions, including:
arranging the pixel points in the reference image in order of the luma values from low to high to determine at least one second cutoff value;
dividing the pixel points in the reference image into the plurality of reference regions based on the at least one second cutoff value.

6. The method of claim 1, wherein the plurality of original regions further comprise a fifth region, and the luma values of the pixel points in the fifth region are greater than the luma values of the pixel points in the first region, or, the luma values of the pixel points in the fifth region are smaller than the luma values of the pixel points in the second region;
the reference regions also comprise a sixth region, wherein the luma values of the pixel points in the sixth region are greater than the luma values of the pixel points in the third region, or the luma values of the pixel points in the sixth region are smaller than luma values of pixel points in the fourth region;
wherein the method also comprises:
obtaining a transformation matrix for the fifth region based on the color values of the pixel points in the fifth region and the color values of the pixel points in the sixth region;
the color mapping the original image according to the transformation matrix for the first region and the transformation matrix for the second region to obtain a target image, comprises:
color mapping the original image according to the transformation matrix for the first region, the transformation matrix for the second region and the transformation matrix for the fifth region, to obtain the target image.

7. (canceled)

8. A computing device, comprising: one or more processor, a memory, and one or more computer programs, wherein the one or more computer programs are stored in the memory, characterized in that when the one or more processors execute the one or more computer programs, the computing device is caused to implement:
dividing an original image into a plurality of original regions, the plurality of original regions at least comprising a first region and a second region, wherein luma values of pixel points in the first region are greater than the luma values of pixel points in the second region,
dividing a reference image into a plurality of reference regions, the reference regions at least comprising a third region and a fourth region, wherein the luma values of pixel points in the third region are greater than the luma values of pixel points in the fourth region,
obtaining a transformation matrix for the first region based on color values of pixel points in the first region and color values of pixel points in the third region, and obtaining a transformation matrix for the second region based on color values of pixel points in the second region and color values of pixel points in the fourth region, and
color mapping the original image according to the transformation matrix for the first region and the transformation matrix for the second region to obtain a target image.

9. A computer storage medium comprising computer instructions, which, when executed on a computing device, cause the computing device to implement.
dividing an original image into a plurality of original regions, the plurality of original regions at least comprising a first region and a second region, wherein luma values of pixel points in the first region are greater than the luma values of pixel points in the second region,
dividing a reference image into a plurality of reference regions, the reference regions at least comprising a third region and a fourth region, wherein the luma values of pixel points in the third region are greater than the luma values of pixel points in the fourth region,
obtaining a transformation matrix for the first region based on color values of pixel points in the first region and color values of pixel points in the third region, and obtaining a transformation matrix for the second region based on color values of pixel points in the second region and color values of pixel points in the fourth region, and
color mapping the original image according to the transformation matrix for the first region and the transformation matrix for the second region to obtain a target image.

10. (canceled)

11. The method of claim 3, wherein, for the transformation matrix for each of the first region and second region, the corrected image corresponding to the transformation matrix is obtained by:
subtracting the color average value of the region from color values of pixel points of the original image to obtain the zero-removed result,
processing the zero-removed result based on the transformation matrix for the region to obtain a transformation result, and
adding the transformation result to the color average value of the reference region to obtain a corrected image corresponding to the transformation matrix.

12. The method of claim 3, wherein, for each of the first region and the second region, the corrected region corresponding to the region is obtained by:
subtracting the color average value of the region from the color value of each pixel in the region to obtain a zero-removed result,
processing the zero-removed result based on the transformation matrix for the region, to obtain the transformation result, and
adding the color average value of the reference region to the transformation result, to obtain the corrected region corresponding to the region.

13. The computing device of claim 8, wherein the obtaining a transformation matrix for the first region based on color values of pixel points in the first region and color values of pixel points in the third region, and obtaining a transformation matrix for the second region based on color values of pixel points in the second region and color values of pixel points in the fourth region, comprising:
calculating a covariance matrix of color channel dimensions corresponding to each of the plurality of original regions, based on the color values of pixel points in the original region;
calculating a covariance matrix of color channel dimensions corresponding to each of the plurality of reference regions, based on the color values of pixel points in the reference region;
determining the transformation matrix for the first region based on the covariance matrix of the color channel dimensions corresponding to the first region and the covariance matrix of the color channel dimension corresponding to the third region; and
determining the transformation matrix for the second region based on the covariance matrix of the color channel dimensions corresponding to the second region and the covariance matrix of the color channel dimension corresponding to the fourth region.

14. The computing device of claim 8, wherein, the color mapping the original image according to the transformation matrix for the first region and the transformation matrix for the second region to obtain a target image, comprising:
processing the color values of pixel points in the original image according to the transformation matrix for the first region to obtain a first corrected image corresponding to the transformation matrix for the first region;
processing the color values of pixel points in the original image according to the transformation matrix for the second region to obtain a second corrected image corresponding to the transformation matrix for the second region; and
fusing the first corrected image and the second corrected image to obtain the target image.

15. The computing device of claim 8, wherein the color mapping the original image according to the transformation matrix for the first region and the transformation matrix for the second region to obtain a target image, comprising:
processing the color values of the pixel points in the first region according to the transformation matrix for the first region to obtain a first corrected region corresponding to the first region;
processing the color values of the pixel points in the second region according to the transformation matrix for the second region to obtain a second corrected region corresponding to the second region; and
stitching the first corrected region and the second corrected region to obtain the target image.

16. The computing device of claim 8, wherein the dividing the original image into the plurality of original regions, comprising:
arranging the pixel points in the original image in order of the luma values from low to high to determine at least one first cutoff value;
dividing the pixel points in the original image into the plurality of original regions based on the at least one first cutoff value;
the dividing the reference image into the plurality of reference regions, including:
arranging the pixel points in the reference image in order of the luma values from low to high to determine at least one second cutoff value;
dividing the pixel points in the reference image into the plurality of reference regions based on the at least one second cutoff value.

17. The computing device of claim 8, wherein the plurality of original regions further comprise a fifth region, and the luma values of the pixel points in the fifth region are greater than the luma values of the pixel points in the first region, or, the luma values of the pixel points in the fifth region are smaller than the luma values of the pixel points in the second region;
the reference regions also comprise a sixth region, wherein the luma values of the pixel points in the sixth region are greater than the luma values of the pixel points in the third region, or the luma values of the pixel points in the sixth region are smaller than luma values of pixel points in the fourth region;
wherein when the one or more processors execute the one or more computer programs, the computing device is caused to further implement:
obtaining a transformation matrix for the fifth region based on the color values of the pixel points in the fifth region and the color values of the pixel points in the sixth region;
the color mapping the original image according to the transformation matrix for the first region and the transformation matrix for the second region to obtain a target image, comprises:
color mapping the original image according to the transformation matrix for the first region, the transformation matrix for the second region and the transformation matrix for the fifth region, to obtain the target image.

18. The computer storage medium of claim 9, wherein the obtaining a transformation matrix for the first region based on color values of pixel points in the first region and color values of pixel points in the third region, and obtaining a transformation matrix for the second region based on color values of pixel points in the second region and color values of pixel points in the fourth region, comprising:
calculating a covariance matrix of color channel dimensions corresponding to each of the plurality of original regions, based on the color values of pixel points in the original region;
calculating a covariance matrix of color channel dimensions corresponding to each of the plurality of reference regions, based on the color values of pixel points in the reference region;
determining the transformation matrix for the first region based on the covariance matrix of the color channel dimensions corresponding to the first region and the covariance matrix of the color channel dimension corresponding to the third region; and
determining the transformation matrix for the second region based on the covariance matrix of the color channel dimensions corresponding to the second region and the covariance matrix of the color channel dimension corresponding to the fourth region.

19. The computer storage medium of claim 9, wherein, the color mapping the original image according to the transformation matrix for the first region and the transformation matrix for the second region to obtain a target image, comprising:
processing the color values of pixel points in the original image according to the transformation matrix for the first region to obtain a first corrected image corresponding to the transformation matrix for the first region;
processing the color values of pixel points in the original image according to the transformation matrix for the second region to obtain a second corrected image corresponding to the transformation matrix for the second region; and
fusing the first corrected image and the second corrected image to obtain the target image.

20. The computer storage medium of claim 9, wherein the color mapping the original image according to the transformation matrix for the first region and the transformation matrix for the second region to obtain a target image, comprising:
processing the color values of the pixel points in the first region according to the transformation matrix for the first region to obtain a first corrected region corresponding to the first region;
processing the color values of the pixel points in the second region according to the transformation matrix for the second region to obtain a second corrected region corresponding to the second region; and
stitching the first corrected region and the second corrected region to obtain the target image.

21. The computer storage medium of claim 9, wherein the dividing the original image into the plurality of original regions, comprising:
arranging the pixel points in the original image in order of the luma values from low to high to determine at least one first cutoff value;
dividing the pixel points in the original image into the plurality of original regions based on the at least one first cutoff value;
the dividing the reference image into the plurality of reference regions, including:
arranging the pixel points in the reference image in order of the luma values from low to high to determine at least one second cutoff value;
dividing the pixel points in the reference image into the plurality of reference regions based on the at least one second cutoff value.

22. The computer storage medium of claim 9, wherein the plurality of original regions further comprise a fifth region, and the luma values of the pixel points in the fifth region are greater than the luma values of the pixel points in the first region, or, the luma values of the pixel points in the fifth region are smaller than the luma values of the pixel points in the second region;
the reference regions also comprise a sixth region, wherein the luma values of the pixel points in the sixth region are greater than the luma values of the pixel points in the third region, or the luma values of the pixel points in the sixth region are smaller than luma values of pixel points in the fourth region;
wherein the computer instructions, which, when executed on a computing device, cause the computing device to further implement:
obtaining a transformation matrix for the fifth region based on the color values of the pixel points in the fifth region and the color values of the pixel points in the sixth region;
the color mapping the original image according to the transformation matrix for the first region and the transformation matrix for the second region to obtain a target image, comprises:
color mapping the original image according to the transformation matrix for the first region, the transformation matrix for the second region and the transformation matrix for the fifth region, to obtain the target image.
